(19) United States
(12) Patent Application Publication
(10) Pub. No.: US 2008/0112690 A1
(43) Pub. Date: May 15, 2008

(54) Personalized local recorded content

(75) Inventors: Behzad Shahraray, Freehold, NJ (US); David Gibbon, Lincroft, NJ (US); Lee Begeja, Gillette, NJ (US); Zhu Liu, Marlboro, NJ (US); Richard V. Cox, New Providence, NJ (US); Bernard S. Renger, New Providence, NJ (US)

Correspondence Address: SCHWEGMAN, LUNDBERG & WOESSNER, P.A., P.O. BOX 2938, MINNEAPOLIS, MN, 55402, US

(73) Assignee: SBC Knowledge Venturses, L.P.

(21) Appl. No.: 11/595,351

(22) Filed: Nov. 9, 2006

(51) Int. Cl. H04N 7/26

(52) U.S. Cl. 386/124

(57) ABSTRACT

A system to personalize a display of content locally recorded at a media device is described herein. A segment having an associated segment identifier is extracted from a broadcast event recorded at the remote media device. Each segment identifier is searched for a match with the user profile data to generate a personalized segment list. Locator code data is associated with each segment of the personalized segment list. The locator code data is transmitted to the media device to be used to extract an image to present the personalized segment list.

### FIELD

The application relates generally to the field of multimedia processing and services, and more specifically to personalized locally recorded content.

### BACKGROUND

Television broadcasting is a linear medium that is temporally delivered. With advances in technology, such as video cassette recorders and digital video recorders (DVR), television viewers have been able to change the temporal nature of television broadcasting. For example, DVRs may record or store television programming content onto a hard drive. Also, DVRs have the ability to skip to previous or next chapters through a remote control button, for instance.

Often programs are recorded as a whole by the DVR. Sometimes users want to view a particular segment of the program, e.g., just the sports news. Further, complementary pieces of information about a topic may be distributed in several different programs. The user may use fast forwarding or rewinding buttons to find the particular segment(s). However, this may be time consuming, and the user may inadvertently skip segment(s) during the navigation process.

Having the ability to search through such large local or remote repositories for specific content is useful, especially to save time. However, the searching and retrieving may be difficult or inefficient and may involve transmitting the video program, or some components of it such as images or text, either for replay at the receiving end or for generating a textual and/or pictorial index of the program. Transmitting the video program requires sufficient bandwidth. In the instance where the specific content is located only in a remote repository, retransmitting the content is inefficient.

### BRIEF DESCRIPTION OF DRAWINGS

An example embodiment of the present invention is illustrated by way of example and not limitation in the figures of the accompanying drawings, in which like references indicate similar elements and in which:

FIG. 1 illustrates a system environment in which one embodiment may be implemented.

FIG. 2 illustrates a block diagram of a personalized segment list extracted from multiple broadcast events according to an example embodiment.

FIG. 3 illustrates a user interface according to an embodiment.

FIG. 4 illustrates a method according to an embodiment.

FIG. 5 shows a diagrammatic representation of machine in the example form of a computer system within which a set of instructions, for causing the machine to perform any one or more of the methodologies discussed herein, may be executed.

FIG. 6 illustrates an Internet Protocol Television (IPTV) system environment in which one embodiment may be implemented.

### DETAILED DESCRIPTION

According to an aspect of the present subject matter, there is provided a system to personalize a display of content locally recorded at a media device. A segment having an associated segment identifier is extracted from a broadcast event recorded at the remote media device. Each segment identifier is searched for a match with the user profile data to generate a personalized segment list. Locator code data is associated with each segment of the personalized segment list. The locator code data is transmitted to the media device to be used to extract an image to present the personalized segment list.

According to another aspect of the present subject matter, the service provider remotely controls the presentation of the personalized segment list, as well as the playback order of the segments in the personalized segment list.

According to yet another aspect of the present subject matter, a service provider may remotely and automatically set the media device to record broadcast event(s) while avoiding retransmission of content, in some embodiments.

In an embodiment, the service provider is remote from the media device, and vice versa depending upon the perspective. For example, the service provider may be spaced at a distance from the media device. In another example, the service provider may communicate with the media device through a network. In embodiments where the service provider is local to the media device, the service provider accesses the media device directly without a telecommunications line, for instance.

In the following description, for the purposes of explanation, numerous specific details are set forth in order to provide a thorough understanding of the disclosed embodiments. It will be apparent, however, to one skilled in the art that the disclosed embodiments may be practiced without some of these specific details. In other instances, well-known structures and devices are shown in block diagram form.

### Example System Environment

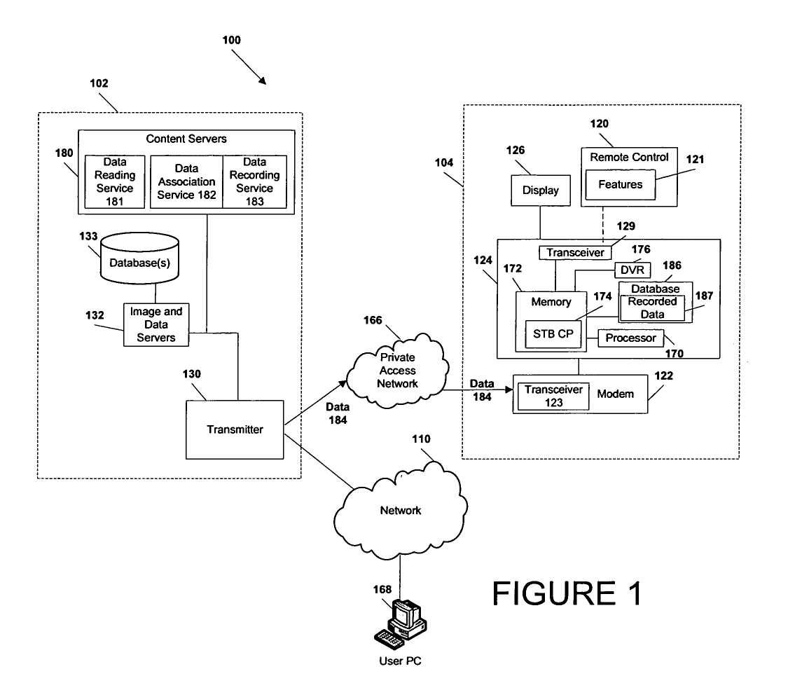

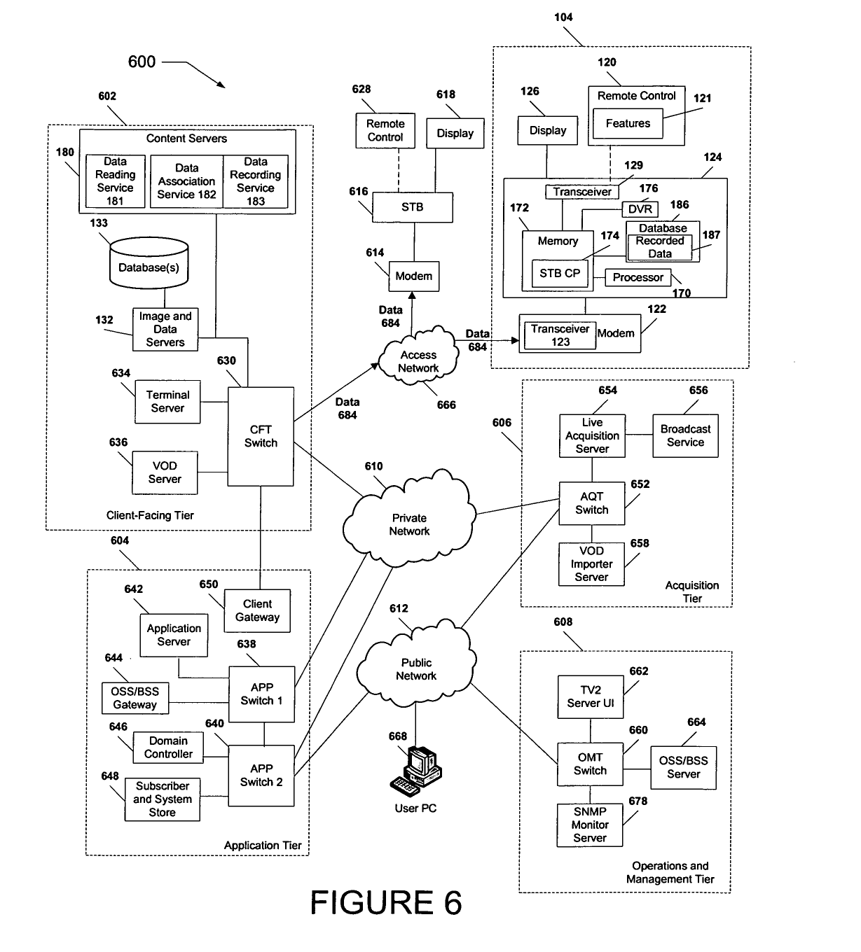

Referring to FIG. 1, an illustrative embodiment of a system that may be used to provide content is illustrated and is generally designated 100. As shown, the system 100 may include a service provider tier 102 and a media device tier 104. Tiers 102, 104 are coupled to network 110, such as the Internet; and to a private access network 166 for communication. The private access network 166 may be, for example, a managed video content services access network or may be an Internet Protocol Television (IPTV) access network, as shown in more detail in FIG. 6.

In an illustrative embodiment, modems, such as a modem 122 may be coupled to the private access network 166. The service provider tier 102 may communicate with a representative media device 124 via the modem 122, for instance. The modem 122 may include a transceiver, such as transceiver 123 of modem 122, to receive and send data 184, for instance. The data 184 may, for instance, include content (e.g., video content, audio content, image content), locator code data representative of the locally recorded content (as described in more detail herein), and/or index display data used to determine a presentation format of the locally recorded content or locally recorded segments in a personalized segment list.

The locator code data of a program or a program segment may include, for instance, a start time of the segment or the program, an end time of the segment or the program, a broadcast channel or access point of the program or the segment, a code associated with the program/segment (e.g., VCR+® code). The locator code data may include any other information that may be useful in recording a program/segment and/or in determining access to a locally recorded program/segment. The locator code data may be used in accessing information related to a locally recorded segment of the content received at the media device. Using the locator code data, images and/or text associated with certain segments (or programs) are extracted from the media device for use in a personalized segment list. The locator code data represents a match between an identifier of a user profile extracted at the remote service provider from the locally recorded content and a segment identifier, as discussed in more detail below.

The index display data may include data related to which of the several locally recorded programs and/or program segments are to be represented in a personalized segment list (as thumbnails, for instance), how they are to be presented, and in which order in the personalized segment list, as well as which component of a program to operate on and what operation to perform on that component (e.g., generate a thumbnail image from the video frame at a given time, or pull out the closed caption text from time t1 to time t2), and any other information that may be useful in the index display format itself, or in representing the segments/ programs in the index display. The index display data may vary with the user profile associated with the media device. The user profile may be manually added to or automatically extracted from the locally recorded content.

The index display data for the presentation of the plurality of segments may include a presentation format, including a presentation order of the plurality of segments in a display through the media device. The order may be determined by the search terms or the search results. For example, a most relevant segment may be displayed in the index of the media device first and/or most prominently.

The transceiver 123 may receive the video content from a video content server 180 (or a service provider) on a first bandwidth, and may receive locator code data from the service provider on a second bandwidth that is lower than the first bandwidth. Embodiments herein may work with different bandwidth systems that combine higher quality bandwidths with narrower bandwidths, such as AT&T's HomeZone® (combining Satellite with DSL) and other embodiments that combine Satellite with WiMax, for example.

In another embodiment, the video content and the locator code data may be sent on the same bandwidth, and the locator code data may be sent quickly, in a short burst.

The video content may be sent on a high quality bandwidth, such as from a satellite source, cable source, IPTV source, on-air source, streaming media from the Internet or media downloaded from the Internet, as in a Podcast®, or any other suitable source. The locator code data may be sent via phone, DSL, WiMax, cable source, wireless source, IPTV source, satellite source, on-air source, or any other suitable source. The locator code data and/or the video content may be sent with an electronic program guide (EPG).

The locator code data is received at the transceiver 123 in response to a search request associated with the recorded video content. Because of the different bandwidths, the locator code data may be transmitted to the user separately from the content. Because the content is not transmitted along therewith (and not retransmitted), the process of searching through the event index data and sending the associated locator code data may be more efficiently performed.

In other embodiments, the content and the locator code data are sent to the media device tier on the same bandwidth, either together or separately, as appropriate. Indexing information and/or the locator code data may be embedded in, and transmitted with, the content (e.g., in one of the lines in the vertical blanking interval for analog TV, or in the MPEG user data for digital TV).

In another embodiment, the locator code data may not be sent to the media device. In this instance, the service provider may log the user profile data in the network, rather than logging the user profile data at the media device.

A lower bandwidth bi-directional communications link may send and/or receive data. For example, through the transceiver 123, the media device 124 may transmit information to a video content server 180 about what program the user is or has viewed to use, for example, in a customized web page, as discussed herein. The information concerning viewed programming may be sent through either a lower or higher bandwidth communications link.

Additionally or alternatively to the content servers 180, data 184 may be generated, associated, and provided by an outside database, the device 124, and/or a user of the device 124, in other embodiments not shown.

The service provider tier 102 may communicate with a large number of set-top boxes, such as the representative set-top box 124, over a wide geographic area, such as a regional area, a metropolitan area, a viewing area, a designated market area or any other suitable geographic area, market area, or subscriber or customer group that may be supported by networking the service provider tier 102 to numerous set-top box devices. In an illustrative embodiment, the client-facing tier, or any portion thereof, may be included at a video head-end office.

The media device 124 may include a cable box, a set-top box, a transmitter, a multifunctional device, a digital video recorder, a television, a mobile device (such as a mobile phone), a video cassette recorder, a personal computer, a multifunctional device, an image recorder (e.g., for pictures), an audio recorder (e.g., for satellite radio), or any other media device. The media device may include a user interface on a display 126 (such as a television monitor) associated with the media device 124, for instance.

In a particular embodiment, the service provider tier 102 may be coupled to modem 122 via fiber optic cables. Alternatively, the modem 122 may be digital subscriber line (DSL) modems that are coupled to one or more network nodes via twisted pairs, and the service provider tier 102 may be coupled to the network nodes via fiber-optic cables. Each set-top box device 124 may process data received via the private access network 166, via an IPTV software platform, such as Microsoft® TV IPTV Edition, as discussed in more detail with regard to FIG. 6.

The device 124 may transmit the data 184 to an external display device, such as the display device 126 for displaying content, such as a broadcast program or event, for instance.

The device 124 may communicate with the remote control 120. The device 124 may include a wireless transceiver (e.g., transmitter and/or receiver) 129 to communicate with a wireless transmitter/receiver (not shown) of the remote control 120.

The set-top box device 124 may communicate commands (i.e., a search request or record an event or view a segment in the index) received from the remote control devices 120 to the service provider tier 102 via the private access network 166.

Further, the set-top box device 124 may include a STB processor, such as STB processor 170, and a STB memory device, such as STB memory 172, which is accessible to the STB processor 170. In one embodiment, a computer program, such as the STB computer program (STB CP) 174, may be embedded within the STB memory device 172.

The memory 172 of the device 124 may be coupled with a database 186 including recorded data 187, e.g., video content locally recorded from a transmission by a service provider. Each set-top box device 124 may also include a video content storage module, such as a digital video recorder (DVR) 176 shown in FIG. 1. In another embodiment, the DVR may be a network DVR.

The device 124 may include components that enable DVR functionality (not shown). For example, at least one analog/digital video tuner may be included in the device 124. The components may be added to the device 124 and to the tier 102 as the user may record an event locally, while the service provider is also recording the event. The device 124 and the service provider may record the event from either the same source or from a different source.

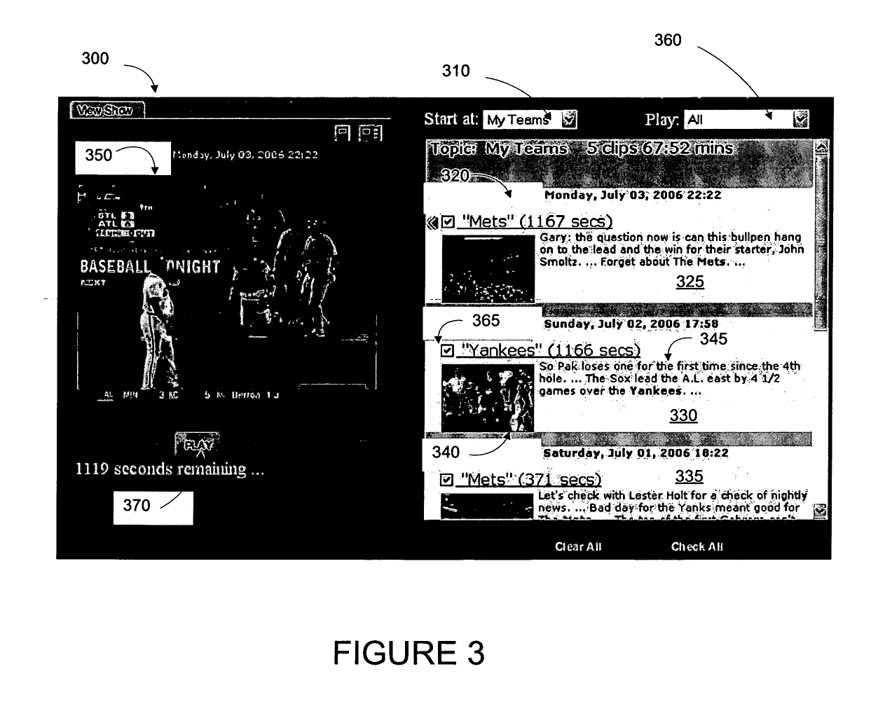

The device 116 further includes logic (e.g., STB CP 174) to record the content, process the locator code data, and to convert the locator code data to the segment display by extracting information from the local content. The locator code data may represent images or frames of the content, and/or may represent textual information of the content. The frames and/or text may be extracted from the DVR content/database given the locator code data (time information and additional information regarding which component of the video data to operate on and what operation to perform (e.g., generate a thumbnail image from the video frame at a given time, or pull out the closed caption text from time t1 to time t2)). The text and images may be extracted from the locally recorded content using the media device to create a personalized user page on the display. The extraction may take place such that it does not involve retransmission of any content from the service provider. It is also possible for the thumbnails (frames) to be transmitted to the user by the service provider. The frames and/or text may become part of the display of FIG. 3, for instance. The frames become thumbnails in the display, and the text may be associated with the frames, accordingly. The thumbnails may be selected by the user to view a corresponding segment of the content.

The client-facing tier 102 may also include one or more content servers 180 (e.g., video content servers) that transmit content requested by viewers via their set-top boxes 116. In an illustrative embodiment, the content servers 180 may include one or more multicast servers. When a search request is submitted via the devices 116, the requests may be transmitted to the content servers 180 to be processed accordingly. The content servers 180 may additionally or alternatively transmit video content, audio content, and/or image content.

The data corresponding to segments of broadcasted events may be automatically extracted using a data reading service 181 of the content servers 180. The data may be extracted from content corresponding to locally recorded content. The extracted data (and the content from which the data is extracted) may be stored on the database 133. The data may include images or frames and associated text. The frames may be representative of the associated segments of the recorded event(s). The data, and in particular, the text, may be searchable using the data association service 182, as described herein.

The data reading service 181 may generate the locator code data for each segment of a personalized segment list, as discussed herein. Again, the locator code data may indicate, for instance, where in a program the data (e.g., thumbnails, segments, and text) representing the particular segment may be located, which programs to extract from, and other appropriate information to generate a personalized display or personalized segment list. The locator code data may also be stored in the database 133 of the service provider. In an additional embodiment, the data may be extracted at the media device, wherein the media device includes the data reading service 181.

While the service provider may store the actual thumbnail images and the text, this information may not be sent to the user in certain instances. The information (e.g., the locator code data) sent to the media device is the action to be taken by the media device to extract the appropriate text and/or images from the locally recorded content at the user's location, such as an executable file, the template into which the extracted information is to be placed, and the timing information associated with this extraction process, as described in more detail below.

The service provider may search the data extracted for event segment(s) associated with the search request from the user, for example, searching for segments showing “My Teams.” The data may be searched by the data association service 182. The search may include data associated with each broadcast event transmitted or received by the content server, regardless of whether the local device 124 received and/or recorded the content. In another embodiment, only the event(s) locally recorded on the media device are searched by the data association service 182, such that the data found in the search (and subsequently transmitted to the media device) exclusively includes data associated with events previously locally recorded. In another additional embodiment, the data may be searched at the media device, wherein the media device 124 includes the data association service 182.

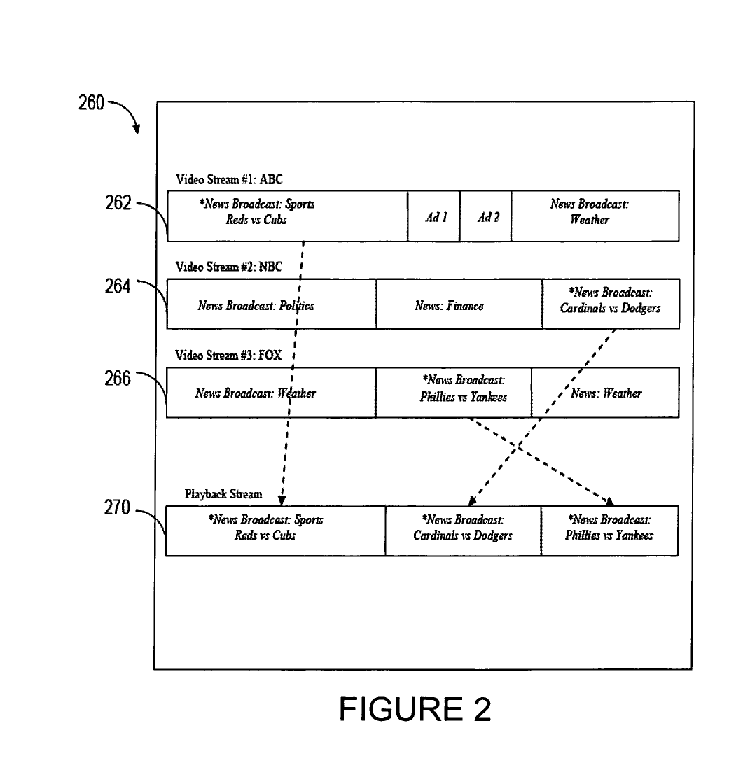

The data reading service 181, at the remote service provider 180, may extract user profile data from a broadcast event (e.g., events 262, 264, 266 of FIG. 2) locally recorded at the media device 124. For example, the user profile data may include the genre or type of program (e.g., movie or news or musical), associated actors or persons, and other useful information helpful in understanding the types of programming that the user(s) may be interested in viewing and/or recording at the media device. In a particular embodiment, the media device may have been set to record baseball events or associated news programs and the user profile data may then include: baseball, news, the teams playing, and other extractable information.

The data reading service 181 may further extract a segment with an associated segment identifier from the locally recorded broadcast event(s) (262, 264, 266), as described herein. The data reading service 181 may further extract a scheduled segment identifier from a scheduled broadcast event. The segment identifier may include metadata, such as subtitles for the associated segment. For instance, the segment identifier may include baseball references, such as Yankees or Mets.

The data association service 182 may match the scheduled segment identifier with the user profile data to generate an event recording list associated with the scheduled broadcast event. The data association service 182 may associate scheduled event locator code data with the event recording list. In an example, the event recording list may include scheduled baseball games or baseball games of certain teams. The more particular the event recording list may depend upon user inputted data associated with their profile, or a longer recording history.

The data association service 182 may search through each segment identifier for a match with the user profile data to generate the personalized segment list 270 of FIG. 2 or the personalized segment list 320 of FIG. 3. (For example, finding each “baseball” related segment identifier and corresponding segment for a particular day and generating the personalized segment list, accordingly. The data association service further may associate locator code data with each segment of the personalized segment list. The locator code data may refer to the baseball segment(s), for instance, so that the media device may receive the reference to the baseball segment(s) through the locator code data without retransmission of legally restricted content.

The data association service may search through each segment identifier associated with a search request 310 of FIG. 3, and with the user profile data, generate the personalized segment list. Because many various program segments may match the user profile data, the search request 310 may limit the personalized segment list to a more manageable list. The segments of the personalized segment list may be prioritized based on a closest match of the user profile data and the search request.

In an embodiment, the media device may be responsive to the data association service 182 to display the personalized segment list, as described herein. The data association service may synchronize the locator code data to the broadcast event locally recorded at the media device, as described herein.

The content server(s) 180 may also include a data recording service 183 to (automatically) set the media device to record each scheduled broadcast event of a personalized event recording list.

In an illustrative embodiment, the client-facing tier 102 may include a client-facing tier (CFT) switch (e.g., a transmitter) 130 that manages communication between the client-facing tier 102 and the private access network 166 and between the client-facing tier 102 and the private network 110. The switch 130 may act as a transmitter to send the locator code data to the media device to display the personalized segment list 320 to personalize replay of the broadcast event locally recorded. The means for transmitting the locator code data to the media device may include the switch 130.

As shown, the CFT switch 130 is coupled to one or more image and data servers 132 for the database(s) 133 that store locator code data associated with images and text of broadcast programs. Means for storing data includes the database of at least one of the service provider and the media device. In one embodiment, the database 133 stores the locator code data, but does not store the associated content and/or the data itself (the images and text). In this way, the database 133 is able to maximize capacity, and retransmission of content to the media device is avoided. The database(s) 133 may also store broadcast events and related information. In an illustrative embodiment, the image and data servers 132 may be a cluster of servers, each of which may store still images, channel and program-related data, or any combination thereof. In this way, the database 133 is able to maximize capacity and retransmission of video content to the media device is avoided.

The storage device 133 may record the user profile data, the segment with the associated segment identifier, the personalized segment list, and the locator code data. The transmitter 130 may send, to the media device, the locator code data to be used to display the personalized segment list 320 of FIG. 3 to personalize replay of the broadcast event locally recorded 350. The transmitter 130 may further send, to the media device, the scheduled event locator code data to automatically set the media device to record each scheduled broadcast event of the event recording list. The event recording list may alternatively or additionally be displayed on a display 350 for the user to select which of the programs, having the searched-for segments, to record. The scheduled event locator code data may be transmitted to the media device separately from the scheduled broadcast event and may be transmitted on a bandwidth that is lower than a bandwidth of the scheduled broadcast event.

### Example Segment List and/or Playback Stream

FIG. 2 illustrates a block diagram of a personalized segment list extracted from multiple broadcast events according to an example embodiment. The personalized segment list may be rearranged in a playback stream including segments from multiple programs.

Broadcast events 262, 264, 266 are locally recorded at the media device 124. The specific division of program content material of the broadcast events 262, 264, and 266 may be in segments, as shown. Each broadcast program may have one or more program segments, as described in more detail with regard to FIG. 2. In program 262, for instance, there are four (4) segments. The program segments may be news, weather, local, sports, entertainment, etc. or the program segments may each be separate news features, for example. The advertisement segments may include clips from scheduled program segments, for example, or other commercial advertisements.

Each program segment may have metadata with one or more themes, such that the program segments may be reorganized by metadata. In an embodiment, the program may have more than two different program segments. In an additional embodiment, the program may have two or more different program segments, other than advertisement segments. The different program segments may be rearranged in a playback or recording mode. For example, the different program segments may be grouped together from a theme of a search request in a playback mode or in a recording mode.

Program 262 has two program segments, each program segment being associated with at least one theme indicated by associated metadata. Some segments may have a common primary theme (e.g., advertisements or News Broadcast). In some embodiments, segments may have a common secondary theme (e.g., car advertisements). Still further, the segments may have a common tertiary theme (News: Sports, Reds v. Cubs).

In some instances, the content data may include metadata corresponding to the program content data. In one particular embodiment, each segment includes metadata which is referred to herein as a segment identifier. Each segment may have a plurality of segment identifiers associated therewith. The metadata may include at least one tag, e.g., a theme, describing the associated program content. The metadata may be used to reorganize presentation of program content, based on user preference or specific user request (e.g., from the search request 310).

The metadata may be gathered from subtitles and/or closed captions, from program transcripts, or from speech recognition, for instance. The metadata may be gathered from program information that is transmitted with the program (if the program previously aired), or from a database, such as the Internet. The program information may include genre (news, movie, or comedy, for instance), actors/actresses, summary, year made, length of program, and other program-related information. The metadata may include terms, such as “Yankees,” or something less specific, such as “baseball.”

The data reading service 181 may extract at least one segment having at least one associated segment identifier from the broadcast events 262, 264, 266. Metadata, or the segment identifier, corresponding to particular program segments of the broadcast program may be extracted using the data reading service 181 of content servers 180 of the client-facing tier 102. The generated metadata (segment identifiers) may be associated with the particular program segment using the data association service 182. Additionally or alternatively to the content servers 180, metadata may be generated, associated, and provided by an outside database, the device 116, 124, and/or a user of the device 116, 124, in other embodiments not shown.

In between each segment is a chapter point that enables a user to quickly move to the beginning of each segment, which may directly follow an advertisement or another program segment. The chapter points (i.e., segmentation) may be determined by a content provider, an outside database, a digital video recorder, and/or a user. The service provider 180 may perform the task of segmenting the video programs into stories, matching the stories with the user's profile of interests (that has been specified ahead of time), and delivering the relevant video segments (or locator code data representative thereof) to the user.

The service provider 180 may receive and maintain an archive of many programs and may retransmit segments (or locator code data representative thereof) of this archive to the user on-demand. Information to create the personalized presentation and personalized segment list 270, such as still frames, text, etc., may be extracted from the local content given the time code information by the service provider. The data association service 182 searches through each of the program segments of each of the multiple programs using the associated metadata to group together the program segments that have the same or searched-for theme, associated with user profile. The presentation of the program segments in the personalized segment list may be reorganized based on user preference or based on a specific user request. For example, priority based on percentage match to user profile metadata.

The metadata or tags of all available recorded (or to be recorded) video streams are matched with the request (or preference). For example, if the user searches for metadata including sports, in particular, baseball related segments, to the exclusion of other content from the multiple programs 262, 264, 266, the rearrangement of the subject matter may be as shown in FIG. 2.

The actual recorded programs may remain unchanged as shown in programs 262, 264, 266, while the playback may look like stream 270. In another embodiment, the actual recorded program may resemble playback stream 270.

Personalized video programs (e.g., playback stream 270) that follow a user's preferences can be created either by authoring a program with the specific narrow topic (e.g., news sports) in mind, or by extracting relevant segments from other programs 262, 264, and 266 that contain several topics/segments. When dealing with TV content, one possible approach may segment a given informational or entertainment program into smaller segments, each covering a particular topic. This segmentation task can be performed by a person or by applying automated algorithms that analyze the different media components of the video program to determine the beginnings and endings of the individual segments (or stories). An example of such an automated system is the eClips system at AT&T that used multimodal story segmentation techniques to segment a given video program 262, 264, 266 into individual stories or segments.

The processor 170 may process the locator code data to extract at least one image and/or text from the recorded content to be presented in the personalized segment list and to process the index display data to determine the presentation of the personalized segment list. The processor 170 may process the scheduled event locator code data and convert the scheduled event locator code data to an event recording list (similar to the list 270) of at least one scheduled broadcast event. The event recording list may be generated based on matches between the user profile and a scheduled segment identifier of the scheduled broadcast event, as discussed herein. The data recording service 183 of the content server 180 may automatically set the media device to record each scheduled broadcast event of the event recording list. Alternatively, or additionally, the event recording list may be presented to the user via the display 350 of FIG. 3 to select the program(s) to record.

Using user profile data, certain portions of content (such as commercials or scenes that are not appropriate for certain audiences) may be skipped or not included in the personalized segment list or playback stream 270.

### Example Interface

FIG. 3 illustrates a user interface 300 according to an embodiment. The user interface 300 may personalize the display 118, 126 for use in replaying selected content locally recorded at the media device 124 or for use in recording selected content at the media device. The thumbnails and associated text may represent an index of segments and may be associated with the search request described herein. The images (or text) may be browsed, using a cursor control device or another user input device, and an image may be selected to jump to the corresponding point in the recorded content.

The features of the user interface 300 may include a search request feature 310 (or search prompt) to reveal the personalized segment list 320 generated by a search request made to the service provider. The data association service may search through each segment identifier associated with the search request 310 and associated with the user profile data to generate the personalized segment list 320.

The search prompt 310 may include a personalized search, such as “My Teams”, weather, politics, finance, movies, comedy programs, cartoons, dramas, special events, or any other type of programming or individual selection. The locator code data associated with the personalized segment list may be received by the media device in response to the search request.

The personalized segment list 320 may be for previously recorded content or for content to be recorded. The personalized segment list includes a reference 325 to at least one segment of the content, wherein the segment includes a segment identifier that matches an identifier of a user profile extracted at the service provider from the recorded content. The locator code data is representative of that match. The segments of the personalized segment list 320 may be prioritized based on how closely the segment identifiers align with the user profile data. The personalized segment list may be generated by extracting an image (and/or text) from content locally recorded at the media device using the locator code data.

The display may present the personalized segment list 320 in the user interface 300 as a personalized replay of the recorded content. The display may present the personalized segment list 320 having at least one segment 325, 330, or 335 of the content associated with the search request. The personalized segment list 320 may include a representation of each segment 325, 330, or 335 of the personalized segment list, the representation being selected from a group including an image thumbnail 340 and text 345. The text may be extracted from the recorded content, such as from closed captions, subtitles or speech recognition, for instance.

The image thumbnails may represent an index of segments of recorded content (or content to be recorded). The thumbnails 340 may be selected by the user for viewing the associated segment or for recording the associated segment. In the first instance, the segment may be associated with locally recorded content. In the second instance, the segment may be associated with content of a scheduled broadcast, or content to be recorded. The segment, thumbnail and text associated with the scheduled broadcast may be from a previous advertisement for that particular scheduled broadcast or may be received from an outside source, for instance. For the content to be recorded, the service provider may remotely program the media device to record from the event recording list. Alternatively, or additionally, the user may select the programs to record based on the event recording list.

Additionally, the features of the user interface may include selection features 360 and 365 to highlight a segment and to make a selection of the highlighted items or segments on the index. The selection feature 360 may enable selection of at least one segment 325, 330, 335 of the personalized segment list 320 for viewing the recorded content associated therewith (or to record the content associated therewith). The user may select which of the segments to view by using the selector 365 at each segment 325, 330, and 335. A check mark in box 365 may indicate which segments are selected. The selection feature 360 may then be used to play all the selected segments, record the selected segments, save the selected segments, delete the selected segments, or any other appropriate action. A program display 350 may be used to view the selected content, e.g., a selected segment from the personalized segment list. The display 350 may include features to stop the program, play 370, pause, skip, rewind, or other appropriate actions with regard to the selected program.

### Flow Chart

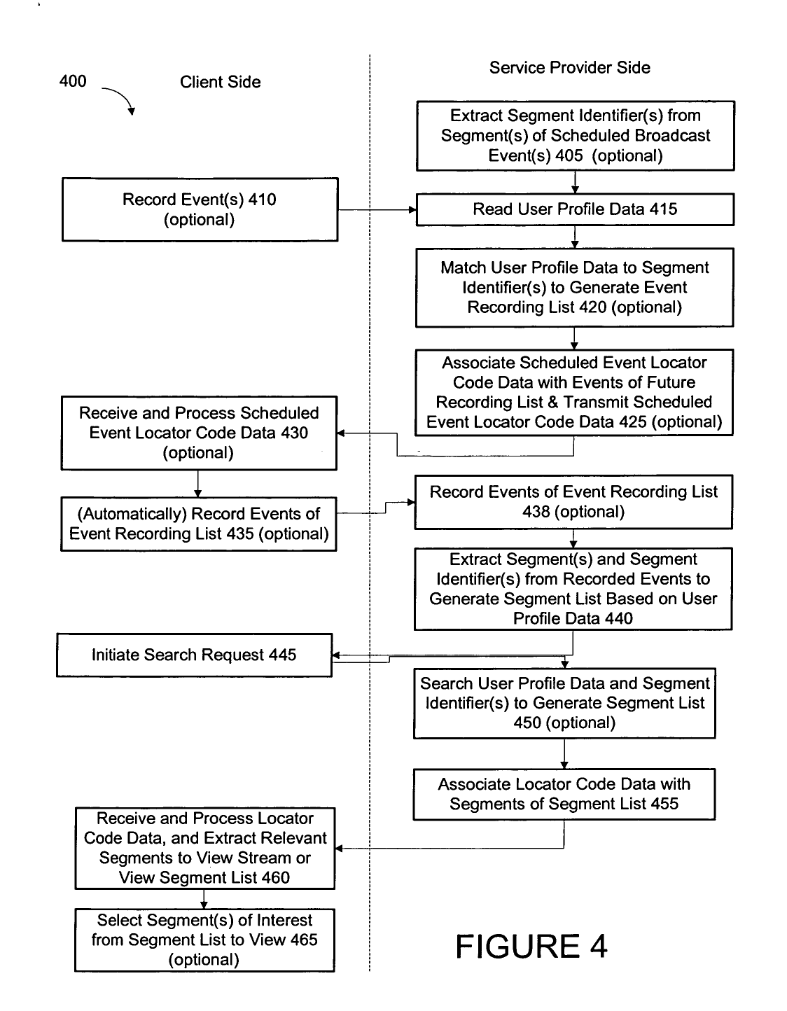

FIG. 4 illustrates an interactive flow chart that demonstrates a method 400 taking place on both the client side and the service provider side, according to an embodiment. The steps described below may be performed under the control of a programmed processor, such as processor 502 and/or processor 170, or the logic may be implemented and distributed among hardware, firmware, software, or a combination thereof within the digital video recorder 176, for example.

In the flow chart, many of the blocks are optional and are generally directed towards an embodiment of recording or generating a list of events to be recorded.

At block 405, the service provider may extract scheduled segment identifier(s) from segment(s) of scheduled broadcast event(s). These scheduled broadcast event(s) are to be airing or broadcasted at a scheduled time. Some of these events may have previously aired. The scheduled segment identifier(s) may include metadata. The scheduled segment identifier(s) may be extracted via the data reading service 181.

At block 410, the user records event(s) on the media device 116, 124, at the client side. The event may be included in the recorded data 187 of the database 186.

The user may schedule a local recording by informing the service provider. The service provider then sends the commands to the set-top-box DVR to program the box to record the content. The service provider then knows which program(s) the user is interested in recording and then may extract the data or information in block 415.

At block 415, on the service provider side, the service provider extracts the user profile data. The service provider may record the same event(s) that the user recorded at block 410 onto the database 133. A service provider receives and processes the same content (from the same source or a different source) and extracts the information related to the personalization for that user. This information is an Edit Decision List (EDL) that specifies which segments of the video are going to be played (or skipped) using a time code. The user profile data may be extracted via the data reading service 181.

The user may specify the user profile in detail. For example, the user may determine which sports teams to follow. The user may determine whether to record an entire game or just highlights. The user may determine on which channels to record which categories (e.g., record only ESPN and major networks for sport category Yankees). The user can decide whether the media device is to record automatically or to present a list of upcoming events to enable more interactive viewing.

At block 420, the scheduled segment identifier may be matched with the user profile data to generate an event recording list associated with the scheduled broadcast event. The scheduled segment identifier(s) may be matched or associated with the user profile data via the data association service 182.

At block 425, scheduled event locator code data may be associated with the events of the event recording list. In particular, the scheduled event locator code data may include information such as the channel for the associated program on the recording list, the start time, the end time, a code representing the program, or any other appropriate information to indicate the program on the recording list. The scheduled event locator code data may then be transmitted to the media device to generate the recording list and/or record the programs of the recording list. The scheduled event locator code data may be transmitted to the media device separately from the scheduled broadcast event and on a separate bandwidth. The scheduled program event(s) may be automatically recorded by the media device in response to the transmission from the service provider. The scheduled event locator code data may be matched or associated with the events of the event recording list via the data association service 182.

At block 430, at least one scheduled broadcast event may be received at transceiver 123 and processed at processor 170 to regenerate the event recording list on the user interface and/or to automatically record the events at block 435.

At block 435, the events of the event recording list may be (automatically) recorded on the database 186 as recorded data 187. Personalized recordings may therefore be remotely scheduled. In some practical service scenarios (e.g., some IPTV services), the process of scheduling a local recording using the customer's DVR is done with the involvement of the service provider. This provides advanced notification to the service provider about what the user is going to record. This information can be used by the service provider to process the content and generate the EDL for use by the user. Moreover, given that the service provider is aware of the user's profile of interest and is likely to have information about the content that will be broadcast in the future, the service provider can remotely program the user's DVR to record certain programs without the need for the user's involvement. These programs will later appear on the user's DVR and will be used in delivering a personalized presentation of the personalized segment list 320.

At block 438, events of the scheduled event recording list may optionally be recorded at the local media device.

At block 440, the service provider may extract segment(s) and/or segment identifier(s) from the recorded event(s) at the service provider. The segments and associated identifiers are extracted based on the user profile data to generate the segment list. The recorded events may be already recorded by the media device, or the recorded events may be the scheduled events that have been recorded. The data may include images or frames and associated text. The frames may be representative of the associated segments of the recorded event(s). The data may include metadata regarding the broadcasted event, for instance, title, genre, date, channel, actor(s), synopsis, or other program information. The data may include content-based (linguistic content) data from the event, such as, closed captions, subtitles, automatic speech recognition (ASR) from the audio track, off-line transcripts, and images of the broadcasted event.

The information (segments and segment identifiers) may be extracted automatically by the data reading service 181 and stored on the database 133. The data reading service 181 may associate the data with locator code data, which indicates specifically where in a program the particular data (e.g., images or text or both) may be located. In an additional embodiment, the data may be extracted at the media device, wherein the media device includes a data reading service similar to the data reading service 181. The means for extracting at least one segment with at least one associated segment identifier from the broadcast event includes the data reading service 181.

The service provider may then generate a personalized segment list, e.g., a personalized playback stream and/or a personalized display/user interface, using the locally recorded content, thereby avoiding both the possible bandwidth limitations between the user and the service provider, as well as the legal issues regarding the content. A segment of a scheduled broadcast event may be presented in the personalized segment list (e.g., after the segment is locally recorded).

At block 445, the user initiates the search request. The search request may be initiated through the prompt 310. The user may use the remote control and the media device to enter the request at the prompt 310 on the display and to submit the search request, as described herein. The search may be a text-based search for metadata, captions, subtitles or other textual information associated with segments of the recorded event(s). The search request may be submitted to the service provider. Segments in the personalized segment list are associated with the search request. The locator code data is received at the media device in response to the search request.

At block 450, user profile data and segment identifier(s) are searched to generate the personalized segment list at the service provider side. Each segment identifier may be searched through for a match with the user profile data to generate the personalized segment list. The service provider may search the data extracted at 440 for event segment(s) associated with the search request at block 445. The data may be searched automatically by the data association service 182. The search may include data associated with each broadcast event transmitted or received by the content server 180, regardless of whether the local device 124 received and/or recorded the content. In another embodiment, only the event(s) locally recorded on the media device are searched by the data association service 182, such that the data found in the search (and subsequently transmitted to the media device) exclusively includes data (e.g., images and text) associated with events previously recorded locally. In another additional embodiment, the data may be searched at the media device, wherein the media device includes the data association service 182.

At block 455, locator code data may be associated with each segment of the personalized segment list at the service provider side. The means for associating may include the data association service 182. The database 133 may record the user profile data, the segment with the associated segment identifier, the personalized segment list, and/or the locator code data. The locator code data may then be transmitted to the media device and/or user via the switch 130.

In an embodiment, the locator code data is associated by a service provider other than the content service provider. For example, the locator code data may be associated with each segment of the segment list by a third party provider.

At block 460, the locator code data is received at the receiver 123 of the client side, and processed at the processor 170. Relevant segments are then extracted from the locally recorded content using the locator code data to either view the segments in the playback stream or to view the segments in the personalized segment list for more interactive viewing. The personalized segment list 320 may be presented in the user interface to personalize replay of the broadcast event locally recorded.

The personalized segment list 320 may be provided by the service provider on the user interface/display to enable efficient content-based navigation of the possible selections. Thumbnail images that compose the list may be created at the user's end on the set-top box (STB) by pulling out certain frames of the video from the locally recorded content based on the information supplied by the service provider in the form of commands that, in addition to other information, carry the time code/frame number for the given frame. It is also possible for the thumbnails to be directly transmitted to the user by the service provider in the instance where the legal concerns are not an issue.

At block 465, one or more segments (e.g., 325, 330, and 335) of interest may be selected from the personalized segment list 320 to view at display 350 using the selection features 360, 365, as described herein.

In the event that the starting time of the content on the DVR does not match the timing of the program that the service provider processed to extract the index, the timing information does not match. There may be several possible reasons for the mismatch. The DVR may not have the correct time and/or the correct starting time of the recording process. Even if the starting times coincide, there may be some compression or expansion of time between the two versions of the recording due to inaccuracies in the respective systems' clock speed, resulting in a gradual shift of time between the two sources. Any possible lack of clock synchronization between the user and service provider or multiple service providers, for example, in case the video information and the index information are supplied by different service providers, may be a reason for mismatch. Further, differences in the starting point of the videos recorded by the user and the service provider due to different amounts of “padding” having to do with how many minutes in advance of the beginning of the program the recording started, may be a reason for mismatch.

Any misalignments between the DVR content and the EDL may be detected, measured, and compensated for by processing a small segment of the DVR content. This alignment based on the audio or video or other media components of the program may be performed through various techniques. To circumvent any issues arising from any time shift between the DVR content and the locator code data, the data is automatically synchronized to the recording on the DVR. Using the data reading service 181, the locator code data may be synchronized to the broadcast event locally recorded at the media device. In particular, timing markers may be inserted in the content. Further, implicit information in the content, such as the audio or the scene-chance information, may be used to establish correct time correspondence between the two sources. For example, the service provider may read a short segment of the audio from the beginning of the video program on the DVR and an end segment; perform audio matching to compute the time shift and time warp between the two sources; and apply corrections to compensate for any difference.

When the content processed by the service provider and the DVR content are temporally synchronized, frames (i.e., thumbnails) corresponding to the locator code data may be extracted from the DVR content given the time information. A segment of text from the closed captions may also be extracted from the local content at the user's side by receiving ‘in’ and ‘out’ times from the service provider. Each segment of text may be associated with one of the frames.

### Computer Architecture

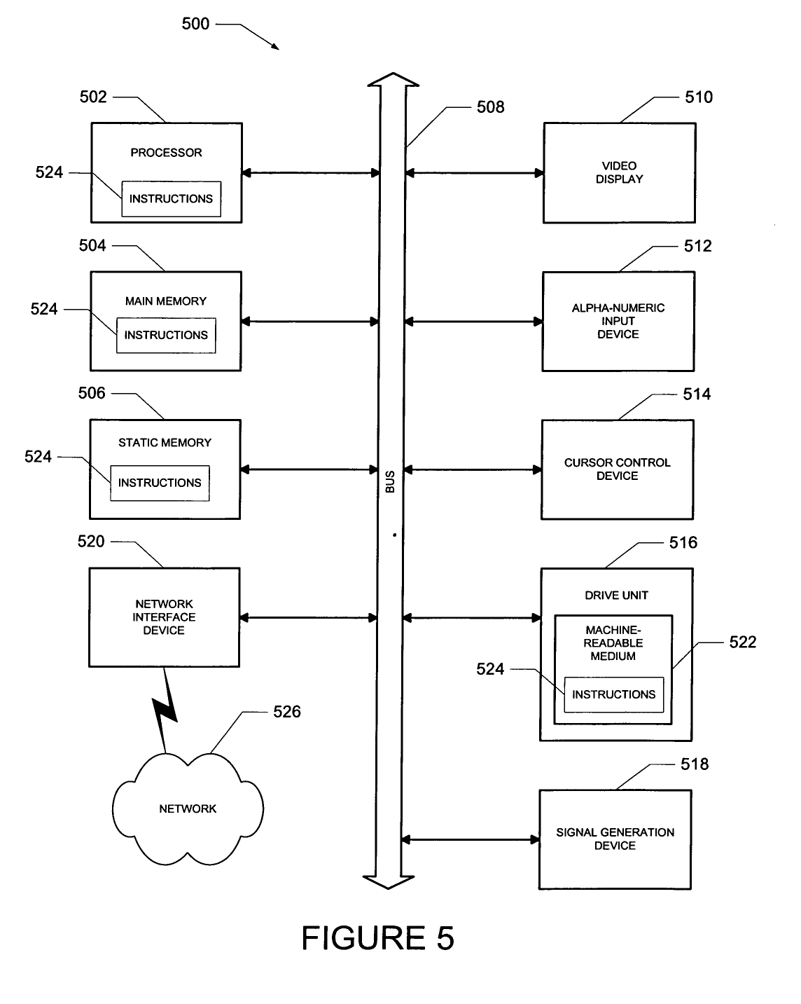

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a digital video recorder (DVR), a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The main memory 504 and/or the static memory 506 may be used to store the recorded programs, and other data or information discussed herein. In an additional embodiment, the data may be stored in volatile memory.

The computer system 500 may further include a video display unit 510 (e.g., a television, a liquid crystal display (LCD) or a cathode ray tube (CRT)) on which to display broadcast or other programs, for example. The computer system 500 also includes an alphanumeric input device 512 (e.g., a keyboard or a remote control), a user interface (UI) navigation device 514 (e.g., a remote control, or a mouse), a disk drive unit 516, a signal generation device 518 (e.g., a speaker) and a network interface device 520.

The input device 512 and/or the navigation device 514 (e.g., the remote control) may include a processor (not shown), and a memory (not shown).

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 and/or the data stream 184 from the content provider may further be transmitted or received over a network 526 (e.g., a television cable provider) via the network interface device 520 utilizing any one of a number of well-known transfer protocols (e.g., broadcast transmissions, HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

### Example Internet Protocol Television System Environment

Referring to FIG. 6, an illustrative embodiment of an Internet Protocol Television (IPTV) system that may be used to provide video content is illustrated and is generally designated 600. As shown, the system 600 may include the media device tier 104, a client facing tier 602, an application tier 604, an acquisition tier 606, and an operations and management tier 608. Each tier 602, 604, 606, 608 is coupled to a private network 610; to a public network 612, such as the Internet; or to both the private network 610 and the public network 612. For example, the client-facing tier 602 may be coupled to the private network 610. Further, the application tier 604 may be coupled to the private network 610 and to the public network 612. The acquisition tier 606 may also be coupled to the private network 610 and to the public network 612. Additionally, the operations and management tier 608 may be coupled to the public network 612.

As illustrated in FIG. 6, the various tiers 602, 604, 606, 608 communicate with each other via the private network 610 and the public network 612. For instance, the client-facing tier 602 may communicate with the application tier 604 and the acquisition tier 606 via the private network 610. The application tier 604 may also communicate with the acquisition tier 606 via the private network 610. Further, the application tier 604 may communicate with the acquisition tier 606 and the operations and management tier 608 via the public network 612. Moreover, the acquisition tier 606 may communicate with the operations and management tier 608 via the public network 612. In a particular embodiment, elements of the application tier 604, including, but not limited to, a client gateway 650, may communicate directly with the client-facing tier 602.

As illustrated in FIG. 6, the client-facing tier 602 may communicate with user equipment via a private access network 666, such as an Internet Protocol Television (IPTV) access network. In an illustrative embodiment, modems, such as a first modem 614 and the modem 122 may be coupled to the private access network 666. The client-facing tier 602 may communicate with a first representative media device 616 via the first modem 614. The client-facing tier 602 has similar characteristics to the service provider tier 102 of FIG. 1. Like reference numerals designate similar elements in the drawing figures.

In a particular embodiment, the client-facing tier 602 may be coupled to the modems 614, 122 via fiber optic cables. Alternatively, the modems 614 and 122 may be digital subscriber line (DSL) modems that are coupled to one or more network nodes via twisted pairs, and the client-facing tier 602 may be coupled to the network nodes via fiber-optic cables. Each set-top box device 616, 124 may process data received via the private access network 666, via an IPTV software platform, such as Microsoft® TV IPTV Edition. The media device 124, 616 may include a user interface for IPTV on a display 126, 618, for instance. The set-top boxes 616, 124 may transmit the data 684 to the external display device 618, 126 for displaying content, such as a broadcast program or event, for instance. The first set-top box device 616 may communicate with a remote control 628.

In an illustrative embodiment, the client-facing tier 602 may include a client-facing tier (CFT) switch 630 that manages communication between the client-facing tier 602 and the private access network 666 and between the client-facing tier 602 and the private network 610. The switch 630 may act as a transmitter to send the content and/or locator code data to the media device. The means for transmitting the locator code data to the media device may include the switch 630.

The CFT switch 630 may also be coupled to a terminal server 634 that provides terminal devices with a connection point to the private network 610. In a particular embodiment, the CFT switch 630 may also be coupled to a video-on-demand (VOD) server 636 that stores or provides VOD content imported by the IPTV system 600.

As illustrated in FIG. 6, the application tier 604 may communicate with both the private network 610 and the public network 612. The application tier 604 may include a first application tier (APP) switch 638 and a second APP switch 640. In a particular embodiment, the first APP switch 638 may be coupled to the second APP switch 640. The first APP switch 638 may be coupled to an application server 642 and to an OSS/BSS gateway 644. In a particular embodiment, the application server 642 may provide applications to the set-top box devices 616, 124 via the private access network 666, which enable the set-top box devices 616, 124 to provide functions, such as display, messaging, processing of IPTV data and VOD material, etc. In a particular embodiment, the OSS/BSS gateway 644 includes operation systems and support (OSS) data, as well as billing systems and support (BSS) data. In one embodiment, the OSS/BSS gateway 644 may provide or restrict access to an OSS/BSS server 664 that stores operations and billing systems data. The BSS may contain or access the watched program log information, for usage billing purposes, for example.

Further, the second APP switch 640 may be coupled to a domain controller 646 that provides web access, for example, to users via the public network 612. For example, the domain controller 646 may provide remote web access to IPTV account information via the public network 612, which users may access using their personal computers 668. The second APP switch 640 may be coupled to a subscriber and system store 648 that includes account information, such as account information that is associated with users who access the system 600 via the private network 610 or the public network 612. In a particular embodiment, the application tier 604 may also include a client gateway 650 that communicates data directly with the client-facing tier 602. In this embodiment, the client gateway 650 may be coupled directly to the CFT switch 630. The client gateway 650 may provide user access to the private network 610 and the tiers coupled thereto.

In a particular embodiment, the set-top box devices 616, 124 may access the IPTV system 600 via the private access network 666, using information received from the client gateway 650. In this embodiment, the private access network 666 may provide security for the private network 610. User devices may access the client gateway 650 via the private access network 666, and the client gateway 650 may allow such devices to access the private network 610 once the devices are authenticated or verified. Similarly, the client gateway 650 may prevent unauthorized devices, such as hacker computers or stolen set-top box devices from accessing the private network 610, by denying access to these devices beyond the private access network 666.

For example, when the first representative set-top box device 616 accesses the system 600 via the private access network 666, the client gateway 650 may verify subscriber information by communicating with the subscriber and system store 648 via the private network 610, the first APP switch 638, and the second APP switch 640. Further, the client gateway 650 may verify billing information and status by communicating with the OSS/BSS gateway 644 via the private network 610 and the first APP switch 638. In one embodiment, the OSS/BSS gateway 644 may transmit a query across the first APP switch 638, to the second APP switch 640, and the second APP switch 640 may communicate the query across the public network 612 to the OSS/BSS server 664. After the client gateway 650 confirms subscriber and/or billing information, the client gateway 650 may allow the set-top box device 616 access to IPTV content and VOD content. If the client gateway 650 cannot verify subscriber information for the set-top box device 616, e.g., because it may be connected to an unauthorized twisted pair, the client gateway 650 may block transmissions to and from the set-top box device 616 beyond the private access network 666.

As indicated in FIG. 6, the acquisition tier 606 includes an acquisition tier (AQT) switch 652 that communicates with the private network 610. The AQT switch 652 may also communicate with the operations and management tier 608 via the public network 612. In a particular embodiment, the AQT switch 652 may be coupled to a live acquisition server 654 that receives television or movie content, for example, from a broadcast service 656. In a particular embodiment during operation of the IPTV system, the live acquisition server 654 may acquire television or movie content. The live acquisition server 654 may transmit the television or movie content to the AQT switch 652, and the AQT switch 652 may transmit the television or movie content to the CFT switch 630 via the private network 610.

Further, the television or movie content may be transmitted to the content servers 180, where it may be encoded, formatted, stored, or otherwise manipulated and prepared for communication to the set-top box devices 616, 124. The CFT switch 630 may communicate the television or movie content (and the locator code data and the index display data) to the modems 614, 122 via the private access network 666. The set-top box devices 616, 124 may receive the television or movie content via the modems 614, 122, and may transmit the television or movie content to the display devices 618, 126. In an illustrative embodiment, video or audio portions of the television or movie content may be streamed to the set-top box devices 616, 124.

In an example, non-limiting embodiment, each set-top box device 616, 124 may receive content data 684, which may include video content and/or audio content or portions thereof, from the client-facing tier 602 via the private access network 666. The content data 684 may be associated with at least one program, such as a broadcast program itself. Multiple programs may be broadcast through the content data 684 at any given time, each with their own program content data.

Further, the AQT switch may be coupled to a video-on-demand importer server 658 that stores television or movie content received at the acquisition tier 606 and communicates the stored content to the VOD server 636 at the client-facing tier 602 via the private network 610. Additionally, at the acquisition tier 606, the video-on-demand (VOD) importer server 658 may receive content from one or more VOD sources outside the IPTV system 600, such as movie studios and programmers of non-live content. The VOD importer server 658 may transmit the VOD content to the AQT switch 652, and the AQT switch 652, in turn, may communicate the material to the CFT switch 630 via the private network 610. The VOD content may be stored at one or more servers, such as the VOD server 636.

When users issue requests for VOD content via the set-top box devices 616, 124, the requests may be transmitted over the private access network 666 to the VOD server 636, via the CFT switch 630. Upon receiving such requests, the VOD server 636 may retrieve the requested VOD content and transmit the content to the set-top box devices 616,124 across the private access network 666, via the CFT switch 630. The set-top box devices 616, 124 may transmit the VOD content to the display devices 618, 126. In an illustrative embodiment, video or audio portions of VOD content may be streamed to the set-top box devices 616, 124.

FIG. 6 further illustrates that the operations and management tier 608 may include an operations and management tier (OMT) switch 660 that conducts communication between the operations and management tier 608 and the public network 612. In the embodiment illustrated by FIG. 6, the OMT switch 660 is coupled to a TV2 server 662. Additionally, the OMT switch 660 may be coupled to an OSS/BSS server 664 and to a simple network management protocol (SNMP) monitor server 678 that monitors network devices within or coupled to the IPTV system 600. In a particular embodiment, the OMT switch 660 may communicate with the AQT switch 652 via the public network 612.

In an illustrative embodiment, the live acquisition server 654 may transmit the television or movie content to the AQT switch 652, and the AQT switch 652, in turn, may transmit the television or movie content to the OMT switch 660 via the public network 612. In this embodiment, the OMT switch 660 may transmit the television or movie content to the TV2 server 662 for display to users accessing the user interface at the TV2 server 662. For example, a user may access the TV2 server 662 using the personal computer (PC) 668 coupled to the public network 612.

Therefore, methods and systems to remotely control the replay and recording of locally recorded video, to create a personalized presentation including selected segments from one or several previously recorded programs, have been described. Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a data reading service to read user profile data, the data reading service further to extract a segment having an associated segment identifier from a broadcast event;
a data association service to search through each segment identifier for a match with the user profile data to generate a personalized segment list, the data association service further to associate locator code data with each segment of the personalized segment list; and
a transmitter to send, to a media device, the locator code data to be used to extract an image to display the personalized segment list.

2. The system of claim 1 wherein the locator code data is transmitted to the media device separately from the broadcast event, wherein the locator code data is selected from a group including: a start time of the segment, an end time of the segment, an access point of the segment, a broadcast channel of the segment, a recording code associated with the segment, any information useful in recording the segment, and any other information useful in determining access to the segment.

3. The system of claim 1 wherein the user profile data is read from the media device, wherein the broadcast event is recorded at the media device.

4. The system of claim 1 wherein the broadcast event is selected from a group including video content, audio content, and image content.

5. The system of claim 1 wherein the personalized segment list includes a representation of each segment of the personalized segment list, the representation being selected from a group including a thumbnail and text.

6. The system of claim 1 wherein the data association service is to search through each segment identifier associated with a search request and with the user profile data to generate the personalized segment list, wherein the segments of the personalized segment list are prioritized.

7. The system of claim 1 wherein:
the data reading service is to extract a scheduled segment identifier from a scheduled broadcast event,
the data association service is to match the scheduled segment identifier with the user profile data to generate an event recording list associated with the scheduled broadcast event,
the data association service is to associate scheduled event locator code data with the scheduled recording list, and
the transmitter is to send, to the media device, the scheduled locator code data to be used to automatically set the media device to record each scheduled broadcast event of the event recording list.

8. The system of claim 7 wherein the scheduled event locator code data is transmitted to the media device separately from the scheduled broadcast event and transmitted on a bandwidth that is lower than a bandwidth of the scheduled broadcast event, wherein the locator code data is transmitted on a bandwidth that is lower than a bandwidth of the broadcast event.

9. A method comprising:
reading user profile data;
extracting a segment having an associated segment identifier from a broadcast event;
searching through each segment identifier for a match with the user profile data to generate a personalized segment list;
associating locator code data with each segment of the personalized segment list; and
transmitting, to a media device, the locator code data to be used to extract an image to present the personalized segment list.

10. The method of claim 9 wherein reading further includes reading the user profile data from the media device, wherein extracting further includes extracting from the broadcast event recorded at the media device, wherein transmitting further includes sending the locator code data to the media device separately from content and communicating on a bandwidth that is lower than a bandwidth of the content.

11. The method of claim 9 further comprising synchronizing the locator code data to the broadcast event recorded at the media device, wherein the locator code data is selected from a group including: a start time of the segment, an end time of the segment, an access point of the segment, a broadcast channel of the segment, a recording code associated with the segment, any information useful in recording the segment, and any other information useful in determining access to the segment.

12. The method of claim 9 further comprising:
extracting a scheduled segment identifier from a scheduled broadcast event;
matching the scheduled segment identifier with the user profile data to generate an event recording list associated with the scheduled broadcast event;
associating scheduled event locator code data with the event recording list; and
transmitting, to the media device, the scheduled event locator code data to be used to automatically set the media device to record each scheduled broadcast event of the event recording list, wherein a recorded segment of the scheduled broadcast event is presented in the personalized segment list in the user interface.

13. A media device system comprising:
a receiver to receive content, locator code data, and index display data from a remote service provider, the content used in locally recording an event, the locator code data used in accessing a segment of the locally recorded event, the index display data used in a presentation of the locally recorded segment in a personalized segment list;
a database to record the content from the remote service provider, wherein the segment includes a segment identifier that matches an identifier of a user profile; and
a processor to process the locator code data to be used to extract an image from the recorded content to be presented in the personalized segment list and to process the index display data to determine the presentation of the personalized segment list.

14. The system of claim 13 wherein the processor is to process the locator code data to be used to extract text associated with the image from the recorded content, the text to be presented in the personalized segment list with the image, wherein the locator code data is selected from a group including: a start time of the segment, an end time of the segment, an access point of the segment, a broadcast channel of the segment, a recording code associated with the segment, any information useful in recording the segment, and any other information useful in determining access to the segment.

15. The system of claim 13 wherein the receiver is to receive scheduled event locator code data from the service provider,
wherein the processor is to process the scheduled event locator code data to be used to extract an event recording list of a scheduled broadcast event, wherein the event recording list is generated based on matches between the user profile and a scheduled segment identifier of the scheduled broadcast event,
wherein the database automatically records the scheduled broadcast event of the event recording list.

16. The system of claim 15 wherein a particular segment of the scheduled broadcast event is presented in the personalized segment list.

17. A method comprising:
receiving content, locator code data, and index display data from a remote service provider, the locator code data used in accessing information related to a locally recorded segment of the received content, the index display data used in a presentation of the locally recorded segment in a personalized segment list;
locally recording the content from a remote service provider, wherein the locally recorded segment includes a segment identifier that matches an identifier of a user profile;
extracting an image from the locally recorded content in response to the locator code data, wherein the image is subsequently presented in the personalized segment list; and
determining the presentation format of the personalized segment list in response to the index display data.

18. The method of claim 17 further comprising extracting text that is to be presented with the image from the locally recorded content in response to the locator code data, wherein the locator code data is selected from a group including: a start time of the segment, an end time of the segment, an access point of the segment, a broadcast channel of the segment, a recording code associated with the segment, any information useful in recording the segment, and any other information useful in determining access to the segment.

19. The method of claim 17 further comprising:
receiving scheduled locator code data from the service provider, extracting an event recording list of a scheduled broadcast event in response to the scheduled event locator code data, wherein the event recording list is generated based on matches between the user profile and a scheduled segment identifier of the scheduled broadcast event; and
automatically recording the scheduled broadcast event of the event recording list.

20. The system of claim 19 further comprising presenting a particular segment of the scheduled broadcast event in the personalized segment list.

21. An interface of a media device, the interface comprising:
a personalized segment list generated by extracting an image from content locally recorded at the media device using locator code data received from a remote service provider, the image in the personalized segment list representative of a segment of the locally recorded content, the segment having a segment identifier, the locator code data representative of a match between an identifier of a user profile and the segment identifier; and
a display section to view the segment selected from the personalized segment list.

22. The interface of claim 21 wherein the personalized segment list is presented according to index display data received from the remote service provider, wherein the index display data varies with the user profile, wherein the index display data may include data related to how the segment is to be represented, a location of the display section relative to the segment list, and in the event there are a plurality of segments, which of the plurality of segments are to be represented in the personalized segment list and in which order, and any other information that may be useful in representing the segment in the index display.

23. The interface of claim 21 further comprising a prompt for a search request, wherein the locator code data is received in response to the search request, and the segment in the personalized segment list is associated with the search request.

24. The interface of claim 21 wherein a particular segment of a scheduled broadcast event is presented in the personalized segment list.

25. The interface of claim 21 wherein the locator code data is used to extract text associated with the image from the locally recorded content, the text to be presented in the personalized segment list associated with the image, wherein the locator code data is selected from a group including: a start time of the segment, an end time of the segment, an access point of the segment, a broadcast channel of the segment, a recording code associated with the segment, any information useful in recording the segment, and any other information useful in determining access to the segment.
